(19) United States
(12) Patent Application Publication
(10) Pub. No.: US 2013/0271583 A1
(43) Pub. Date: Oct. 17, 2013

(54) WIRELESS COMMUNICATION SYSTEM AND WIRELESS COMMUNICATION METHOD USING SAME

(71) Applicant: HON HAI PRECISION INDUSTRY CO., LTD., New Taipei (TW)

(72) Inventor: JEN-TSORNG CHANG, New Taipei (TW)

(73) Assignee: HON HAI PRECISION INDUSTRY CO., LTD., New Taipei (TW)

(21) Appl. No.: 13/779,721

(22) Filed: Feb. 27, 2013

(30) Foreign Application Priority Data
Apr. 11, 2012 (TW) 101112715

(51) Int. Cl. H04N 7/18; G06K 7/14

(52) U.S. Cl. CPC H04N 7/18; G06K 7/1408
USPC 348/61; 235/375

(57) ABSTRACT

A wireless communication system includes an active electronic device for generating and sending a wireless communication request and at least one passive electronic device for responding to the wireless communication request of the active electronic device. Each of the at least one passive electronic devices has an identity character visible on at least a portion thereof. The active electronic device includes an image capturing unit for capturing an image of a passive electronic device, a storage unit for storing the image captured by the image capturing unit and predetermined identity characters, an identifying unit for identifying the identity character in the image and comparing the identity character to the stored identity characters to determine an identity of the passive electronic device, and a control unit for controlling the active electronic device to send a wireless communication request to the passive electronic device.

### BACKGROUND

1. Technical Field

The present disclosure relates to a wireless communication system and a wireless communication method using the wireless communication system.

2. Description of Related Art

Electronic devices can establish a wireless communication with each other. A wireless communication method includes steps: each of two or more electronic devices is assigned with a name representing an identity, wireless communication functions of the two or more electronic devices are turned on, a searching function of one of the electronic devices, which serves as an active electronic device is turned on to search for the other electronic device(s), the other electronic devices acting as passive electronic device(s), the active electronic device shows a list of names of discovered passive electronic device(s) to a user, the user can select one or more of the discovered device(s); a wireless communication request is sent to the selected passive electronic device(s); the wireless communication request is shown on the selected passive electronic device(s), the selected passive electronic device can be operated by the user to accept or to reject wireless communication request. Such a wireless communication method is complicated and inconvenient.

What is needed therefore is a wireless communication system and a wireless communication method addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic view of a wireless communication system, according to an exemplary embodiment of the present disclosure.

FIG. 2 is a schematic view of an active electronic device of the wireless communication system of FIG. 1.

FIG. 3 is a flowchart of a wireless communication method, according to another exemplary embodiment of the present disclosure.

### DETAILED DESCRIPTION

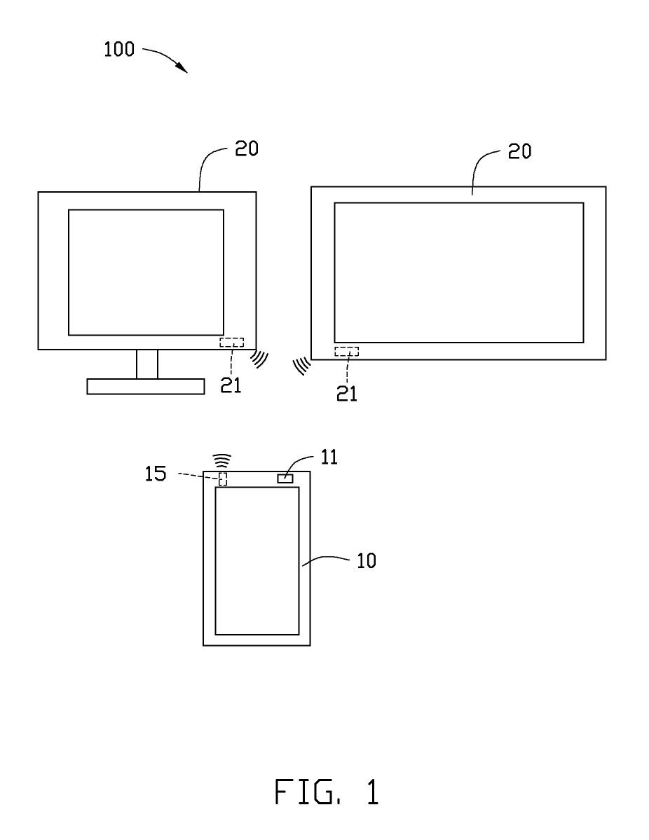

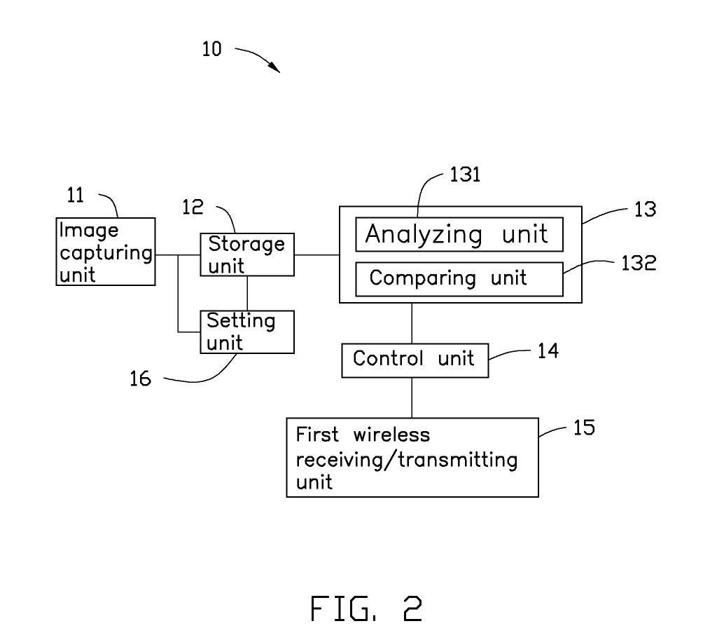

Referring to FIGS. 1-2, a wireless communication system 100, according to an exemplary embodiment, is shown. The wireless communication system 100 includes an active electronic device 10 and a number of passive electronic devices 20. The active electronic device 10 is configured for generating and sending a wireless communication request to one or more passive electronic devices 20. The passive electronic devices 20 are configured for receiving and responding to the wireless communication request to establish a wireless communication with the active electronic device 10. The active electronic device 10 is a portable electronic device, such as mobile phone or a digital camera. Each of the passive electronic devices 20, such as a television and/or a desktop computer, is larger than the active electronic device 10 and is thus regarded as non-portable. In this embodiment, the active electronic device 10 is a mobile phone, one of the passive electronic devices 20 is a television, and another passive electronic device 20 is a desktop computer. Each passive electronic device 20 includes an identity character representing an identity thereof, and the identity is shown on at least a portion of the passive electronic device 20.

The active electronic device 10 includes an image capturing unit 11, a storage unit 12, an indentifying unit 13, a control unit 14, and a first wireless receiving/transmitting unit 15.

The image capturing unit 11 captures an image of a passive electronic device 20 to which a wireless connection is desired. The image capturing unit 10 can be a charge-coupled device (CCD) or a complementary metal oxide semiconductor (CMOS).

The storage unit 12 stores the image captured by the image capturing unit 11, including predetermined and visible identity characters of the passive electronic devices 20 and functions (operation orders) available on and corresponding to the passive electronic devices 20. The predetermined identity characters represent the identity of each passive electronic device 20, and the predetermined identity characters can be shape or symbol characters or textual characters. In addition, the predetermined identity characters may include control passwords relating to the passive electronic devices 20. Using the control passwords, the active electronic device 10 can control the passive electronic devices 20 in a wireless communication. The operation orders are operations and functions of the passive electronic devices 20, including turning on/off the wireless communication function of the passive electronic device 20.

The identifying unit 13 identifies the passive electronic device 20 according to the image captured by the image capturing unit 11. The identifying unit 13 includes an analyzing module 131 and a comparing module 132. The analyzing module 131 establishes the identity character contained in the captured image, and the comparing module 132 compares the identity character so established to a number of predetermined identity characters stored in the storage unit 20 and determines the identity of a particular passive electronic device 20.

The control unit 14 controls the first wireless receiving/transmitting unit 15 to wirelessly receive/transmit information including information as to the identity of the particular passive electronic device 20 which has been determined by the identifying unit 13. In the illustrated embodiment, the control unit 14 may be a processor.

The first wireless receiving/transmitting unit 15 sends a wireless communication request to establish a wireless communication between the active electronic device 10 and the identified passive electronic device 20, under the control of the control unit 14. When a wireless communication takes place, the first wireless receiving/transmitting unit 15 can transmit information to and receive information from the identified passive electronic device 20.

In this embodiment, the active electronic device 10 further includes a setting unit 16. The setting unit 16 allows a user to enter and edit the predetermined identity characters of one or more passive electronic devices 20, such as the shapes, the patterns and/or the control passwords of the one or more passive electronic devices 20. The setting unit 16 also allows the user to register a predetermined identity character for his own active electronic device as a passive electronic device.

Each of the passive electronic devices 20 includes a second wireless receiving/transmitting unit 21. The active electronic device 10 and the passive electronic devices 20 can establish a wireless communication by cooperation between the first wireless receiving/transmitting units 15 and the second wireless receiving/transmitting unit 21. The first wireless receiving/transmitting units 15 and the second wireless receiving/transmitting unit 21 communicate with each other via a wireless technology, such as wireless fidelity (WIFI) or BLUETOOTH.

In use, the active electronic device 10 captures an image of a passive electronic device 20 to which a connection is desired; the identifying unit 13 identifies an identity character within the captured image, compares the identity character to the predetermined identity characters stored in the storage unit 14, and determines an identity of the passive electronic device 20 to which a connection is desired; the control unit 14 controls the first wireless receiving/transmitting unit 15 to send a wireless communication request to the identified passive electronic device 20, including a control password if a control password is needed. The first wireless receiving/transmitting unit 15 sends the control password with the wireless communication request; the passive electronic device 20 will respond to the wireless communication request to establish a wireless communication with the active electronic device 10.

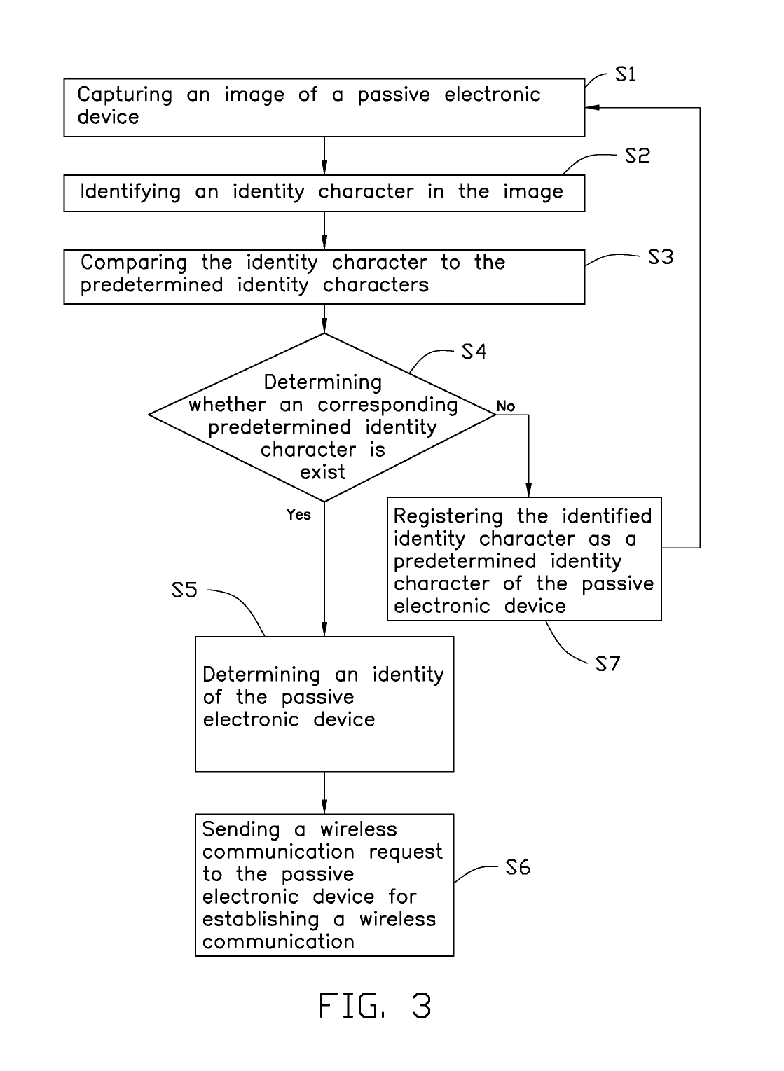

Referring to FIG. 3, another exemplary embodiment of a wireless communication method using the wireless communication system 100 includes the following steps:

In step S1, an image of a passive electronic device 20 is captured by the active electronic device 10;

In step S2, an identity character within the captured image is identified by the identifying unit 13;

In step S3, the identified identity character is compared to all the predetermined identity characters stored in the storage unit 12;

In step S4, a search for a match within the predetermined identity characters existing in the storage unit is made, if yes (a match is found), step S5-S6 is executed, if no, step S7 is executed;

In step S5, an identity of the passive electronic device 20 is found and determined;

In step S6, a wireless communication request is sent to the passive electronic device 20 by the active electronic device 10, and then a wireless communication is established between the active electronic device 10 and the passive electronic device 20.

In step S7, the identity character identified by the identifying unit 13 is registered in the storage unit 12 as a new predetermined identity character of the passive electronic device 20, the registered passive electronic devices 20 can then be identified again by step S1-S5.

The wireless communication system 100 and the wireless communication method using the wireless communication system 100 employ the image capturing unit 11 and the identifying unit 13 in the active electronic device 10 to capture an image of a passive electronic device 20 and to be able to identify the passive electronic device 20, establishing a wireless communication between the active electronic device 10 and the passive electronic device 20 becomes easier and more convenient.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

1. A wireless communication system comprising:
an active electronic device configured for generating and sending a wireless communication request; and
at least one passive electronic device configured for responding the wireless communication request of the active electronic device to establish a wireless communication with the active electronic device;
wherein each of the at least one passive electronic device has an identity character visible on at least a portion thereof, the active electronic device comprises an image capturing unit, a storage unit, identifying unit and a control unit, the image capturing unit is configured for capturing an image of a specific one of the at least one passive electronic device, the storage unit is configured for storing the image captured by the image capturing unit and predetermined identity characters, the identifying unit is configured for identifying the identity character in the image and comparing the identity character to the predetermined identity characters to determine an identity of the specific passive electronic device, and the control unit is configured for controlling the active electronic device to send the wireless communication request to the specific passive electronic device upon a condition that the specific passive electronic device is identified by the identifying unit.

2. The wireless communication system of claim 1, wherein the predetermined identity characters comprise a shape character of the specific passive electronic device.

3. The wireless communication of claim 1, wherein the predetermined identity characters comprise a type character of the specific pass electronic device.

4. The wireless communication system of claim 1, wherein the predetermined identity characters comprise bar codes.

5. The wireless communication system of claim 1, wherein the predetermined identity character corresponding to the specific passive electronic device comprises a control password for acquiring a control right of the specific passive electronic device.

6. The wireless communication system of claim 1, wherein the identifying unit comprises an analyzing module and a comparing module, the analyzing module is configured for finding out the identity character of the specific passive electronic device contained in the image, and the comparing module is configured for comparing the identity character to the predetermined identity characters and determining the identity of the specific passive electronic device.

7. The wireless communication system of claim 1, wherein the active electronic device further comprises a setting unit, and the setting unit allows a user to customize the predetermined identity characters stored in the storage unit.

8. The wireless communication system of claim 7, wherein the setting unit further allows the user to register a predetermined identity character of a passive electronic device which has not been registered any predetermined identity character in the storage unit.

9. The wireless communication system of claim 1, wherein the image capturing unit is selected from one of a group consisting of charge-coupled device and complementary metal oxide semiconductor.

10. The wireless communication system of claim 1, wherein the active electronic comprises is a first wireless receiving/transmitting unit, each of the at least one passive electronic device comprises a second wireless receiving/transmitting unit corresponding to the first wireless receiving/transmitting unit, and the active electronic device and each of the at least one passive electronic devices establish a wireless communication by a cooperation of the first wireless receiving/transmitting units and the second wireless receiving/transmitting unit.

11. A wireless communication method using the wireless communication system as claimed in claim 1, comprising steps:
capturing an image of a passive electronic device;
identifying an identity character in the image;
comparing the identity character to the predetermined identity characters;
determining an identity of the passive electronic device;
sending a wireless communication request to the passive electronic device for establishing a wireless communication.

12. The wireless communication method of claim 11 wherein in the step of comparing the identity character to the predetermined identity characters, if there is no predetermined identity character corresponded to the identity character, the identified identity character is registered in the storage unit as an predetermined identity character of the passive electronic device.
